(19) United States
(12) Patent Application Publication
(10) Pub. No.: US 2010/0170925 A1
(43) Pub. Date: Jul. 8, 2010

(54) ACCESSORY HOLDER FOR HANDLEBARS

(75) Inventors: Darrel Wayne Osten, Coos Bay, OR (US); Lisa Jayne Reid, Portland, OR (US)

Correspondence Address: KOLISCH HARTWELL, P.C., 200 PACIFIC BUILDING, 520 SW YAMHILL STREET, PORTLAND, OR, 97204, US

(73) Assignee: W.C.C., INC., Coos Bay, OR (US)

(21) Appl. No.: 12/348,602

(22) Filed: Jan. 5, 2009

(51) Int. Cl. B62J 11/00; A47F 5/00

(52) U.S. Cl. 224/414; 248/309.1

(57) ABSTRACT

An accessory-holding assembly is provided for holding portable accessories on a set of handlebars. The assembly includes an elongate member sized to receive two or more general-purpose clips often associated with portable accessories. The elongate member may be part of an accessory holder that can be removed, with the accessories still attached, from the handlebars. This allows a rider to remove a plurality of portable accessories from the handlebars in a single action so that the rider can carry the entire accessory holder, including the accessories, into an area where bicycles are not permitted (e.g., an office). The elongate bar may also be attached to a bracket at its two ends to define a space therebetween so that part of each general purpose clip can be inserted into the space. If the space has proper dimensions, the clip is not likely to fall out while the rider is riding.

### BACKGROUND

Multiple devices exist for securing items on handlebars of bicycles, mopeds, motorcycles and other similar vehicles. Some of these devices, such as those disclosed in U.S. Pat. No. 6,315,182, are capable only of securing items having a particular shape or complimentary configuration. Others, such as those described in U.S. Pat. No. 4,981,243, utilize complimentary portions of adhesive material, such as Velcro, to secure an item to a device. All patents and patent applications referenced herein are incorporated by reference for all purposes.

Additionally, many portable accessories such as cellular telephones, pagers, portable music players (e.g., iPod®), global position systems, pocket computers, walkie-talkies and the like include various forms of general-purpose clips for securing the accessories to various objects. Many of these general-purpose clips are similarly sized because they are designed to be secured to objects of similar size, including belts and arm straps.

### SUMMARY

An accessory-holding assembly is provided for holding portable accessories such as cellular telephones, pagers and portable music devices to a set of handlebars. The assembly includes an elongate member such as a bar or strap that is sized to receive two or more general-purpose clips often associated with portable accessories. The elongate bar may be part of an accessory holder that can be removed, with the accessories still attached, from one or more clamps that are secured to the handlebars. This allows the rider to remove a plurality of portable accessories from the handlebars in a single action so that the rider can carry the entire accessory holder, including the accessories, into an area where bicycles are not permitted (e.g., an office). The elongate bar may also be attached to a bracket at its two ends to define a space therebetween so that part of each general purpose clip can be inserted into the space. If the space has proper dimensions, the clip is not likely to fall out while the rider is riding.

### BRIEF DESCRIPTION OF THE DRAWINGS

FIG. 1 is a view of one embodiment of an accessory-holding assembly including an accessory holder that is removed from associated handlebar clamps.

FIG. 2 is a view of the accessory-holding assembly of FIG. 1, including an accessory holder shown secured to associated handlebar clamps, which in turn are secured to handlebars (shown in phantom).

FIG. 3 is a view of another embodiment of an accessory-holding assembly, similar to the ones shown in FIGS. 1 and 2 except that the clamps are arranged so that the receiving members are above, instead of below, the handlebars.

FIG. 4 depicts an alternative embodiment of an accessory-holding assembly where the pins are integrally formed on the handlebars and the receiving members, which define apertures to receive the pins, are part of the accessory holder.

FIG. 5 depicts an alternative embodiment of an accessory-holding assembly where apertures are defined in the handlebars and the accessory holder includes pins sized to be inserted into the apertures.

FIG. 6 depicts an alternative embodiment where the pin includes a spring-loaded member for securing the pin in the aperture.

FIG. 7 depicts an example cup holder that may be attached to the accessory-holding assembly.

FIG. 8 depicts an alternative embodiment of an accessory-holding assembly where the accessory holder is not removable from the clamps and the elongate member is a nylon strap tautly attached to a bracket.

FIG. 9 depicts a side cutout view of the embodiment of FIG. 8 showing the space between the nylon strap and the bracket.

### DETAILED DESCRIPTION

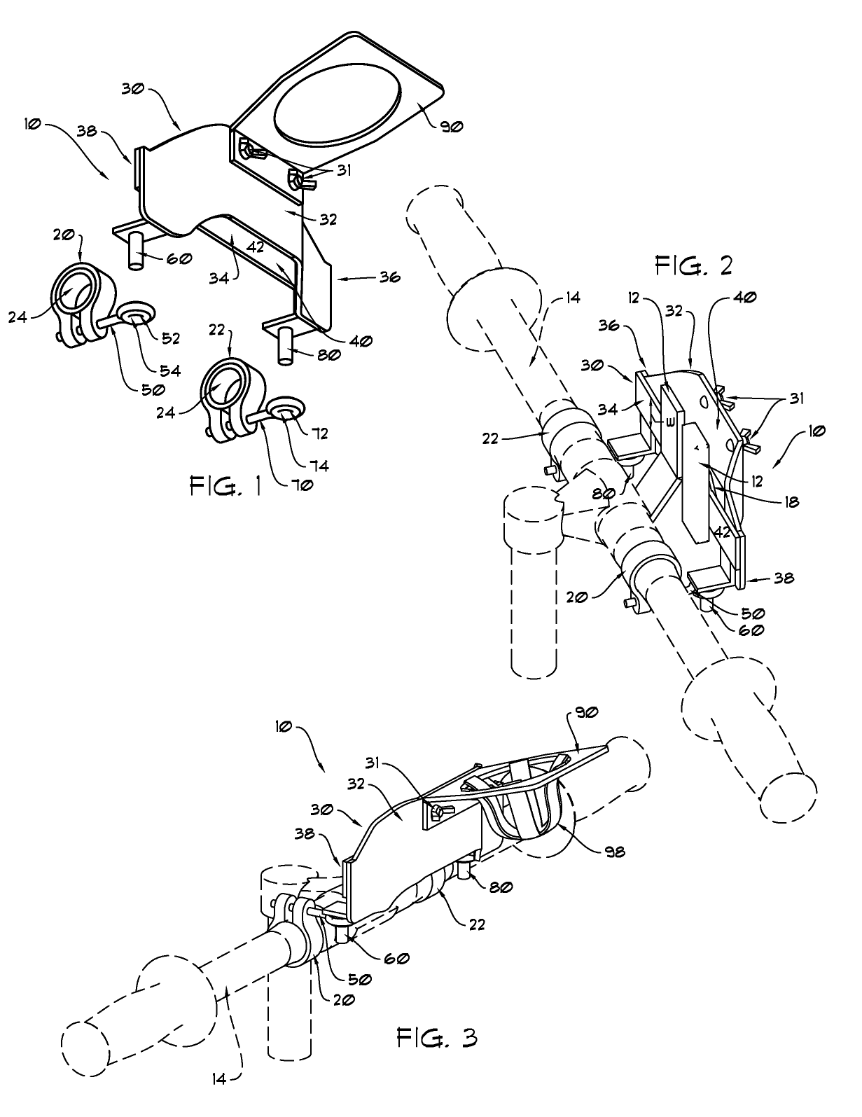

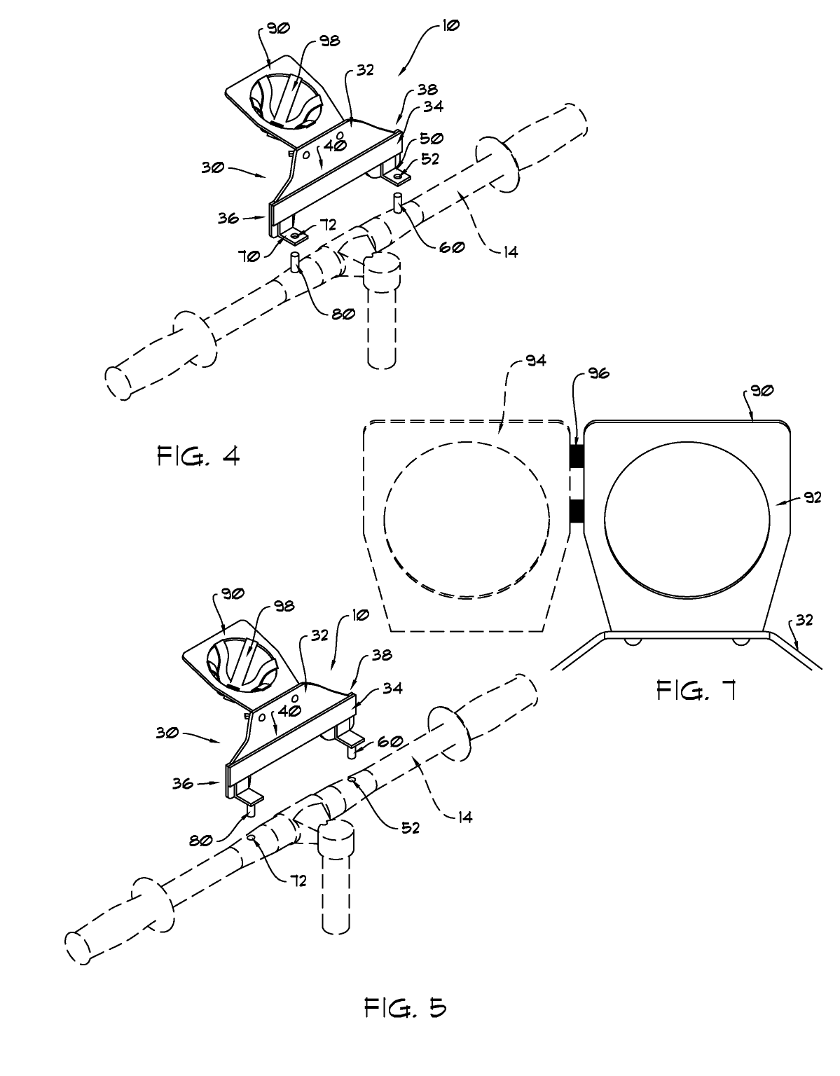

Referring now to FIGS. 1-3, an accessory-holding assembly 10 is provided for securing items such as accessory 12 to a set of handlebars 14 of a bicycle (not shown) using connecting devices such as a clip 18. Although repeated reference to a bicycle will be made herein, it should be understood that accessory-holding assembly 10 may be used with any vehicle having handlebars, including motorcycles, mopeds, scooters and the like.

Accessory-holding assembly 10 may be mounted to handlebars 14 using any number of suitable devices, such as one or more clamps. In the embodiments shown in the drawings, accessory-holding assembly 10 includes a first clamp 20 and a second clamp 22 for mounting accessory holding assembly 10 to handlebars 14. First clamp 20 and second clamp 22 each include a shim 24 for secure retention of the clamps on handlebars 14 so that the clamps will not rotate about or move laterally along the length of handlebars 14.

First and second clamps may be secured at various positions on handlebars 14. For example, second clamp 22 may be adapted to be secured to handlebars 14 at a position spaced from first clamp 20. Securing the clamps at positions spaced from one another, as well as at various positions relative to handlebars 14, allows for accessory-holding assembly 10 to be mounted on a bicycle or other vehicle without interfering with centrally-mounted headlights or other equipment.

Accessory-holding assembly 10 may include an accessory holder 30 for securing accessories such as accessory 12 to handlebars 14. Accessory holder 30 may include a bracket 32 and an elongate member 34 attached to bracket 32 at a first end 36 and a second end 38 so that a portion of elongate member 34 in between the first and second ends is spaced from bracket 32, defining a space 40 between the two.

Elongate member 34 may be sized to receive two or more general-purpose clips associated with two or more portable accessories such as accessory 12. In some embodiments, elongate member 34 may have a length of between about 10 cm and about 25 cm, and thus may be capable of holding several portable accessories in a row. In other embodiments, elongate member 34 may have a length of between about 5 cm and about 10 cm, and thus may be capable of holding two or perhaps three portable accessories. Elongate member 34 may have other dimensions similar to a typical belt. For example, in some embodiments, elongate bar 34 is between about 2 cm and about 4 cm wide (indicated by arrow W in FIG. 2) and between about 2 mm and about 5 mm thick.

In some embodiments, elongate member 34 is rigid and includes one or both of plastic and metal. A surface 42 of elongate member 34 may be slide resistant to prevent accessories such as accessory 12 from shifting during movement. To be slide resistant, elongate member 34 may be at least partially made of and/or include slide-resistant material (e.g., rubber, urethane) on its surface 42. In other embodiments, such as those depicted in FIGS. 8 and 9, elongate member 34 is a nylon strap 46.

In some embodiments, accessory holder 30 may be removable from the one or more clamps (20, 22) that are secured to handlebars 14. This allows a rider to remove a plurality of portable accessories from handlebars 14 in a single movement. The rider then can carry the entire accessory holder, including the accessories, into an area where bicycles are not permitted (e.g., an office building).

One or more pins and corresponding apertures may be provided so that accessory holder 30 is removably attachable to handlebars 14. For example, a first receiving member 50 defining a first aperture 52 may be mounted on or integrally formed with either first clamp 20 or somewhere on accessory holder 30 (e.g., on bracket 32 or elongate member 34). A corresponding first pin 60 may be mounted on or integrally formed with the other of first clamp 20 and accessory bolder 30. “Corresponding” is used herein to indicate that first pin 60 is sized to fit within first aperture 52.

In the exemplary embodiments depicted in the drawings, a second receiving member 70 defining a second aperture 72 is mounted on or integrally formed with either second clamp 22 or somewhere on accessory holder 30 (e.g., on bracket 32 or elongate member 34). Likewise, a second pin 80 is mounted on or integrally formed with the other of second clamp 22 and accessory holder 30. Similar to first pin 60 and first aperture 52, second pin 80 may be sized to fit within second aperture 72.

Pins and/or apertures may also be integrally formed on handlebars 14. For example, FIG. 4 depicts an embodiment where first pin 60 and second pin 80 are integrally formed on handlebars 14. First receiving member 50 and second receiving member 70 are formed as part of accessory holder 30, and define first aperture 52 and second aperture 72, respectively. In another embodiment shown in FIG. 5, first aperture 52 and second aperture 72 are integrally formed on handlebars 14. First pin 60 and second pin 80 are formed as part of accessory holder 30.

Various mechanisms may be employed in order to securely retain the pins into the apertures of the receiving members. For example, FIG. 6 depicts an embodiment where first pin 60 includes a hollow interior 62 with an opening. A spring-loaded member 64 may be nominally positioned to extend at least partially out from hollow interior 62 through the opening. In this configuration, the portion of spring-loaded member 64 that is biased out of the opening with a spring 66 prevents movement of first pin 60 in the direction indicated by the arrow A. Thus, first pin 60 is secured in first aperture 52 of receiving member 50 while a rider rides the bicycle. A rider may exert force on spring-loaded member 64 in the direction indicated by the arrow B (and against spring 66) to move spring-loaded member 64 into hollow interior 62, thus allowing free movement of first pin 60 in the direction indicated by the arrow A.

Additionally or alternatively, first aperture 52 of first receiving member and/or second aperture 72 of second receiving member 70 may be lined with slide-resistant material, such as rubber or urethane, configured to frictionally retain the pins in the apertures. Likewise, first pin 60 and/or second pin 80 may contain or be coated with slide-resistant material. In either case, the slide resistant material increases the resistance between the surfaces of the pins and the inner surfaces of the apertures, decreasing the likelihood that the pins will accidentally slide out of the apertures.

Other mechanisms for securing pins into apertures may be employed. For example, first pin 60 may be provided with threads, and first aperture 52 may have complimentary threading, so that accessory holder 30 may be screwed onto the handlebars.

In embodiments such as the ones depicted in FIGS. 1-3, first clamp 20 and second clamp 22 may be secured at various positions relative to handlebars 14. For example, in FIG. 2, the clamps are secured to handlebars 14 so that first receiving member 50 and second receiving member 70 are below handlebars 14. In contrast, the clamps of the embodiment of FIG. 3 are secured to handlebars 14 so that the receiving members are above handlebars 14. The configuration shown in FIG. 3 results in accessory holder 30 being positioned well above handlebars 14, allowing for placement of a headlight or other similar equipment on the center of handlebars 14.

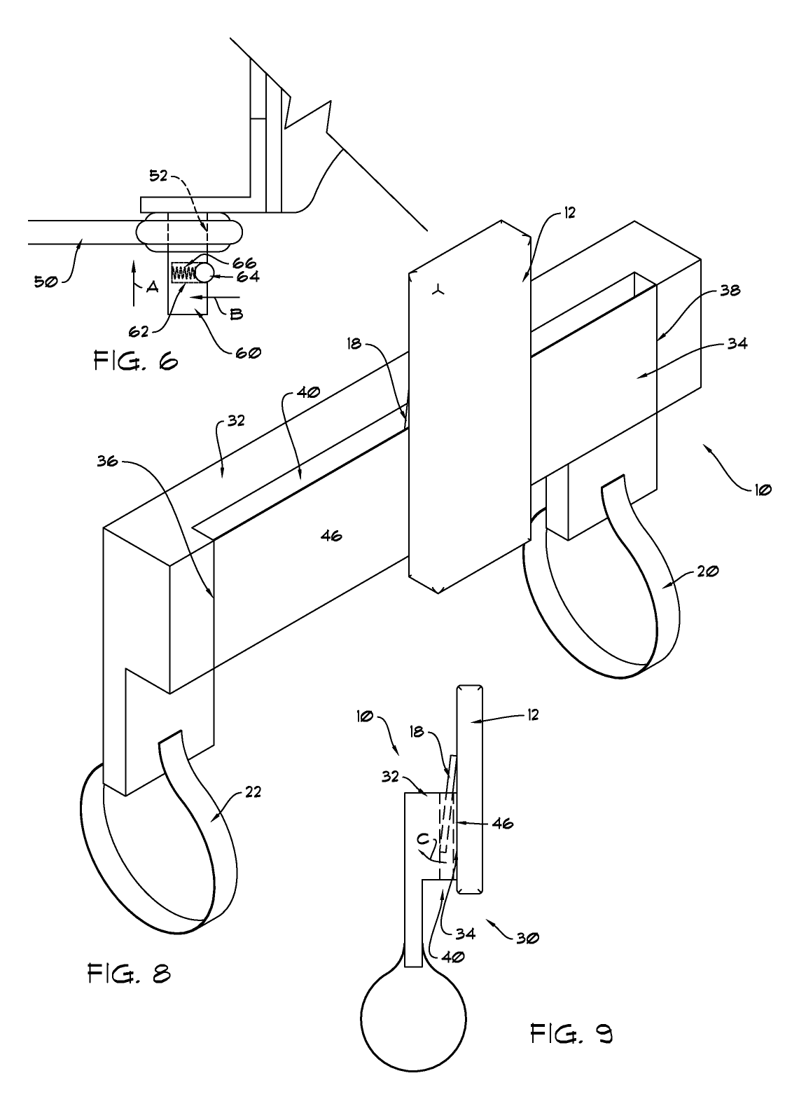

Some embodiments include additional components for holding specific items on handlebars 14. For example, in the embodiments shown in FIGS. 1, 3-5 and 7, a cup holder 90 is mounted to bracket 32 using one or more screws 31 engaged with one or more screw holes. As seen in FIG. 7, cup holder 90 may include a first hoop 92 and a second hoop 94 connected with a hinge 96. One of the first and second hoops may be rotatable between a position where it is concentric with and on top of the other of the first and second hoops and a second position wherein it is adjacent to the other of the two hoops (shown in phantom in FIG. 7). With a hoop in the second position, the rider may carry more than one beverage on handlebars 14. In some embodiments, such as those depicted in FIGS. 3-5, cup holder 90 includes a basket 98, which allows the rider to carry beverages that do not have a tapered shape, such as a can of soda.

Another embodiment is depicted in FIGS. 8 and 9. In this embodiment, elongate member 34 is a nylon strap 46 tautly secured to bracket 32 at its first end 36 and second end 38. Although in this example, accessory holder 30 is not shown being removable from first clamp 20 and second clamp 22, it should be understand that some embodiments include both an accessory holder 30 that is removable from the clamps and a nylon strap 46.

Referring to FIG. 9, elongate member 34 (nylon strap 46 in FIGS. 8 and 9) and bracket 32 are spaced-apart in between first end 36 and second end 38 of elongate member 34 so that a space 40 is formed therebetween. In some embodiments, space 40 is between about 0.5 cm and about 3 cm wide. This range was chosen carefully. It provides enough room for the insertion of a portion of a clip 18 into space 40, while not providing enough room for the inserted portion of clip 18 to rotate in the direction indicated by the arrow C when jarred by movement of the bicycle. This is particularly important in embodiments where elongate member 34 is not thick enough alone to adequately support an accessory clip 18, such as embodiments where elongate member 34 is a nylon strap 46.

It is believed that the disclosure set forth above encompasses multiple distinct embodiments with independent utility. While each of these embodiments has been disclosed in its preferred form, the specific embodiments thereof as disclosed and illustrated herein are not to be considered in a limiting sense as numerous variations are possible. The subject matter of the disclosure includes all novel and non-obvious combinations and sub-combinations of the various elements, features, functions and/or properties disclosed herein. Similarly, where the disclosure recites “a” or “a first” element or the equivalent thereof, such disclosure should be understood to include incorporation of one or more such elements, neither requiring nor excluding two or more such elements.

Various combinations and sub-combinations of features, functions, elements, and/or properties may be claimed in a related application. Such new claims, whether they are directed to a different invention or directed to the same invention, whether different, broader, narrower or equal in scope to any original claims, are also regarded as included within the subject matter of the present disclosure.

What is claimed is:

1. An accessory-holding assembly comprising:
a first clamp adapted to be secured to handlebars; and
an accessory holder adjacent the first clamp and including:
a bracket; and
an elongate member mounted on the bracket at first and second ends of the elongate member so that a portion of the elongate member in between the first and second ends is spaced from the bracket, the elongate member being sized to receive two or more general-purpose clips associated with two or more portable accessories.

2. The accessory-holding assembly of claim 1, further comprising:
a first receiving member mounted on one of the first clamp and the accessory holder and defining a first aperture; and
a first pin mounted on the other of the first clamp and the accessory holder, the first pin being sized to fit into the first aperture;
wherein the accessory holder is removably attachable to the first clamp by inserting the first pin into the first aperture.

3. The accessory-holding assembly of claim 2, further comprising:
a second clamp adapted to be secured to the handlebars at a position spaced from the first clamp by a first distance;
a second receiving member mounted on one of the second clamp and the removable accessory holder and defining a second aperture; and
a second pin mounted on the other of the second clamp and the removable accessory holder, the second pin being sized to fit into the second aperture;
wherein the accessory holder is removably attachable to the second clamp by inserting the second pin into the second aperture, and when the accessory holder is attached to the first and second clamps, the first pin is spaced from the second pin by a distance approximately equal to the first distance.

4. The accessory-holding assembly of claim 1, wherein the elongate member is a nylon strap tautly attached to the bracket at the first and second ends.

5. The accessory-holding assembly of claim 1, wherein the elongate member is rigid and is includes at least one of metal and plastic.

6. The accessory-holding assembly of claim 1, wherein a surface of the elongate member is slide-resistant.

7. The accessory-holding assembly of claim 1, wherein the elongate member includes slide-resistant material on its surface.

8. The accessory-holding assembly of claim 1, wherein the elongate member is between about 2 cm and about 4 cm wide.

9. The accessory-holding assembly of claim 1, wherein the elongate member is spaced from the bracket at a distance of between about 0.5 cm and about 3 cm.

10. The accessory-holding assembly of claim 1, wherein the elongate member is between about 2 mm and about 4 mm thick.

11. The accessory-holding assembly of claim 1, further comprising a cup holder mounted to the bracket, the cup holder including two hoops connected to each another with a hinge, wherein one of the two hoops is rotatable between a position where it is concentric with and on top of the other of the two hoops and a position wherein it is adjacent to and not concentric with the other of the two hoops.

12. The accessory-holding assembly of claim 2, wherein the first aperture is lined with a material configured to frictionally retain the first pin in the first aperture.

13. The accessory-holding assembly of claim 12, wherein the material includes at least one of rubber and urethane.

14. The accessory-holding assembly of claim 2, wherein the first pin includes a hollow interior with an opening and a spring-loaded member movable from a nominal position where the spring-loaded member at least partially extends out from the hollow interior through the opening and an active position where the spring-loaded member is substantially contained within the hollow interior.

15. An accessory-holding assembly adapted to be secured to handlebars, comprising:
an accessory holder including:
a bracket; and
an elongate member mounted on the bracket at first and second ends of the elongate member so that a portion of the elongate member in between the first and second ends is spaced from the bracket at a distance of about 0.5 cm to about 3 cm, the elongate member being sized to receive two or more general-purpose clips associated with two or more portable accessories; and
first and second clamps attached to the accessory holder at positions spaced apart by a first distance and adapted to secure the accessory holder to the handlebars.

16. The accessory-holding assembly of claim 15, further comprising:
a first receiving member mounted on one of the first clamp and the accessory holder and defining a first aperture;
a first pin mounted on the other of the first clamp and the accessory holder, the first pin being sized to fit into the first aperture;
a second receiving member mounted on one of the second clamp and the accessory holder and defining a second aperture; and
a second pin mounted on the other of the second clamp and the accessory holder, the second pin being sized to fit into the second aperture;
wherein the accessory holder is removably attachable to the first and second clamps by inserting the first pin into the first aperture and inserting the second pin into the second aperture, and when the removable accessory holder is attached to the first and second clamps, the first pin is spaced from the second pin by a distance approximately equal to the first distance.

17. A method of securing portable accessories to handlebars of a vehicle, comprising:
attaching a removable accessory holder configured to receive two or more general-purpose clips associated with two or more portable accessories to the handlebars by inserting a first pin mounted on one of the handlebars and the removable accessory holder into a first aperture defined by a first receiving member mounted on the other of the handlebars and the removable accessory holder; and
securing a portable accessory to the removable accessory holder using the portable accessory's general-purpose clip.

18. The method of claim 17, wherein attaching the removable accessory holder further comprises:
inserting a second pin mounted on one of the handlebars and the removable accessory holder into a second aperture defined by a second receiving member mounted on the other of the handlebars and the removable accessory holder.

19. The method of claim 17, further comprising removing the removable accessory holder while the portable accessory is still secured to the portable accessory holder by removing the first pin from the first aperture.

20. The method of claim 19, further comprising the step of, prior to removing the removable accessory holder, manipulating a spring-loaded member from a nominal position where the spring-loaded member at least partially extends out from a hollow interior of the first pin through an opening to an active position where the spring-loaded member is substantially contained within the hollow interior of the first pin.
